(19) United States
(12) Patent Application Publication
(10) Pub. No.: US 2017/0186048 A1
(43) Pub. Date: Jun. 29, 2017

(54) SYSTEMS AND METHODS FOR BLENDING CONTENT ITEMS

(71) Applicant: Facebook, Inc., Menlo Park, CA (US)

(72) Inventor: Bradley Ray Green, Snohomish, WA (US)

(21) Appl. No.: 14/980,887

(22) Filed: Dec. 28, 2015

(51) Int. Cl. G06Q 30/02; G06Q 50/00

(52) U.S. Cl. CPC G06Q 30/0275; G06Q 30/0246; G06Q 50/01

(57) ABSTRACT

Systems, methods, and non-transitory computer-readable media can determine respective rates at which one or more types of content items were presented to users of the social networking system over a period of time. Each content item can be associated with a respective bid. Further, content items are presented through impression opportunities based at least in part on a real-time bidding auction. A determination is made that the respective rates measured over the period of time are inconsistent with a specified mix of the types of content items to be presented. The respective bids associated with content items of at least a first type are adjusted by a corresponding bid weight, wherein the bids are adjusted to enforce the specified mix.

### FIELD OF THE INVENTION

The present technology relates to the field of content provision. More particularly, the present technology relates to techniques for blending content items.

### BACKGROUND

Today, people often utilize computing devices (or systems) for a wide variety of purposes. Users can use their computing devices to, for example, interact with one another, access content, share content, and create content. In some cases, content items can include postings from members of a social networking system. The postings may include text and media content items, such as images, videos, and audio. The postings may be published to the social networking system for consumption by others.

Under conventional approaches, a user may navigate to or be presented with various content items in a social networking system. The content items may be, for example, advertisements and/or entities that are accessible through the social networking system. The advertisements and/or entities presented to the user may have been determined to be of interest to the user, for example, based on the actions taken by the user while interacting with other content items in the social networking system. In one example, the advertisements and/or entities may be presented based in part on other content items that the user has previously accessed through the social networking system.

### SUMMARY

Various embodiments of the present disclosure can include systems, methods, and non-transitory computer readable media configured to determine respective rates at which one or more types of content items were presented to users of the social networking system over a period of time. Each content item can be associated with a respective bid. Further, content items are presented through impression opportunities based at least in part on a real-time bidding auction. A determination is made that the respective rates measured over the period of time are inconsistent with a specified mix of the types of content items to be presented. The respective bids associated with content items of at least a first type are adjusted by a corresponding bid weight, wherein the bids are adjusted to enforce the specified mix.

In an embodiment, the mix specifies a ratio of content items of the first type to content items of a second type.

In an embodiment, the mix specifies a ratio of at least content items of the first type, to content items of a second type, and to content items of a third type.

In an embodiment, the systems, methods, and non-transitory computer readable media are configured to determine the respective bid weight for content items of the first type based at least in part on the respective rates measured over the period of time.

In an embodiment, the systems, methods, and non-transitory computer readable media are configured to determine respective rates at which the one or more types of content items were presented to users of the social networking system over a subsequent period of time, determine that the respective rates measured over the subsequent period of time are inconsistent with the specified mix, determine a new bid weight for content items of the first type based at least in part on the respective rates measured over the subsequent period of time, and cause the respective bids associated with content items of the first type to be adjusted by the new bid weight.

In an embodiment, the systems, methods, and non-transitory computer readable media are configured to determine that a difference between the respective rates and the specified mix exceeds a tolerance value.

In an embodiment, the systems, methods, and non-transitory computer readable media are configured to cause the respective bids associated with content items of at least a second type to be adjusted by a bid weight corresponding to the second type, wherein the bids are adjusted to enforce the specified mix.

In an embodiment, the systems, methods, and non-transitory computer readable media are configured to cause the respective bid associated with each content item of the first type to be increased based at least in part on the bid weight.

In an embodiment, the systems, methods, and non-transitory computer readable media are configured to cause the respective bid associated with each content item of the first type to be decreased based at least in part on the bid weight.

In an embodiment, the types of content items include at least one of advertisements or various entities accessible through the social networking system.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example content exchange module, according to an embodiment of the present disclosure.

FIG. 2 illustrates an example of a control module configured to regulate a mixture of content items, according to an embodiment of the present disclosure.

FIG. 3 illustrates an example diagram illustrating the blending of content item types, according to an embodiment of the present disclosure.

FIG. 4 illustrates an example process for blending content item types, according to an embodiment of the present disclosure.

FIG. 5 illustrates another example process for blending content item types, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Blending Content Items

Today, people often utilize computing devices (or systems) for a wide variety of purposes. Users can use their computing devices to, for example, interact with one another, access content, share content, and create content. In some cases, content items can include postings from members of a social networking system. The postings may include text and media content items, such as images, videos, and audio. The postings may be published to the social networking system for consumption by others. Under conventional approaches, a user may navigate to or be presented with various content items in a social networking system. The content items may be, for example, advertisements and/or entities that are accessible through the social networking system. The content items presented to the user may have been determined to be of interest to the user. For example, such interest may be determined based on actions taken by the user while interacting with other content items in the social networking system.

In addition to advertisements, there may be many different types of entities among the content items that are eligible to be presented to users. An entity may reference a page, user profile, group, story, place (e.g., point of interest, city, etc.), or status updates, to name some examples. Moreover, some entities may be categorized differently based on their characteristics. In one example, pages can be categorized as either large pages (e.g., pages that have a threshold number of fans) or small pages (e.g., pages whose fans number less than a threshold value). In various embodiments, a content item must be associated with a winning bid before the content item will be presented to a user. That is, an online auction (e.g., real-time bidding auction) is typically conducted when there is an impression opportunity. Content items (e.g., advertisements and/or entities) that are candidates for fulfilling the impression opportunity are each associated with a respective bid specified by their respective buyer or advertiser. The content item with the winning bid is typically selected to fulfill the impression opportunity and, as a result, is presented to a user. Given the nature of such auctions, the content items that are ultimately presented to users can vary. As a result, it may be difficult to control the rates at which certain types of content items are presented to users. For example, if advertisements are always associated with the highest bids, then page recommendations are unlikely to be shown.

An improved approach rooted in computer technology overcomes the foregoing and other disadvantages associated with conventional approaches specifically arising in the realm of computer technology. In various embodiments, the mix of various content item types presented to users of the social networking system can be regulated. For example, the mix may be defined using percentages, fractions, or ratios. For example, a specified mix may indicate that page recommendations should be presented 25 percent of the time while all other types of content items should be presented 75 percent of the time. In various embodiments, the actual mix of content item types being presented through the social networking system can be measured periodically. This actual mix can be evaluated to determine whether corrective action is needed to enforce the desired mix. In various embodiments, the mix can be enforced by adjusting the respective bids associated with content items. In one example, corrective action can be taken when the actual mix indicates that, over some period of time, page suggestions were presented 20 percent of the time but the desired mix requires them to be presented 25 percent of the time. In this example, the respective bids associated with page suggestions can be increased automatically by some determined amount, or weight, to help ensure that the page suggestions will secure more impression opportunities in the future. Such corrective actions can be performed iteratively across one or more cycles until the desired mix is satisfied.

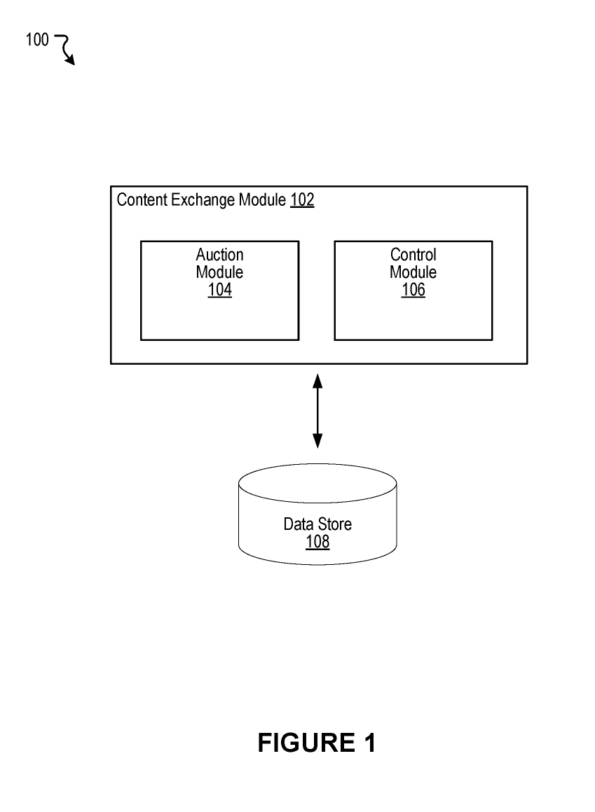

FIG. 1 illustrates an example system 100 including an example content exchange module 102, according to an embodiment of the present disclosure. As shown in the example of FIG. 1, the content exchange module 102 can include an auction module 104 and a control module 106. In some instances, the example system 100 can include at least one data store 108. The components (e.g., modules, elements, etc.) shown in this figure and all figures herein are exemplary only, and other implementations may include additional, fewer, integrated, or different components. Some components may not be shown so as not to obscure relevant details.

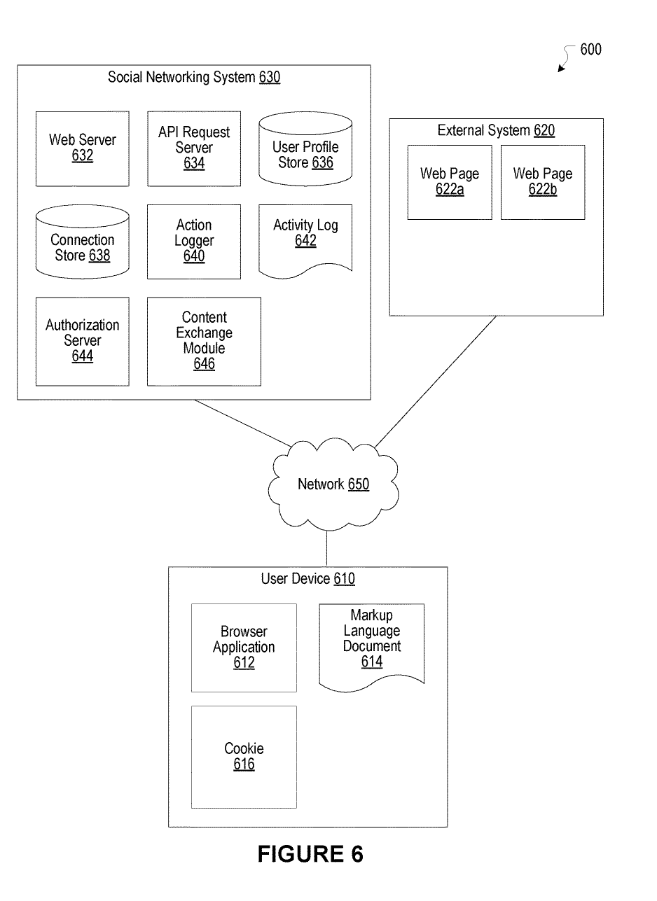

In some embodiments, the content exchange module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the content exchange module 102 can be implemented, in part or in whole, as software running on one or more computing devices or systems, such as on a user or client computing device. In one example, the content exchange module 102 or at least a portion thereof can be implemented as or within an application (e.g., app), a program, or an applet, etc., running on a user computing device or a client computing system, such as the user device 610 of FIG. 6. In another example, the content exchange module 102 or at least a portion thereof can be implemented using one or more computing devices or systems that include one or more servers, such as network servers or cloud servers. In some instances, the content exchange module 102 can, in part or in whole, be implemented within or configured to operate in conjunction with a social networking system (or service), such as the social networking system 630 of FIG. 6.

The content exchange module 102 can be configured to communicate and/or operate with the at least one data store 108, as shown in the example system 100. The data store 108 can be configured to store and maintain various types of data including, for example, respective mix specified for various content items, the actual mix (e.g., measured across one or more periods of time) at which the various types of content items are being presented in the social networking system, and the respective bid weights for various content types, for example, for a given cycle or iteration. In some embodiments, the desired mix, actual mix, and bid weights are separately stored for each channel. In some implementations, the data store 108 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the data store 108 can store information associated with users, such as user identifiers, user information, profile information, user specified settings, content produced or posted by users, and various other types of user data.

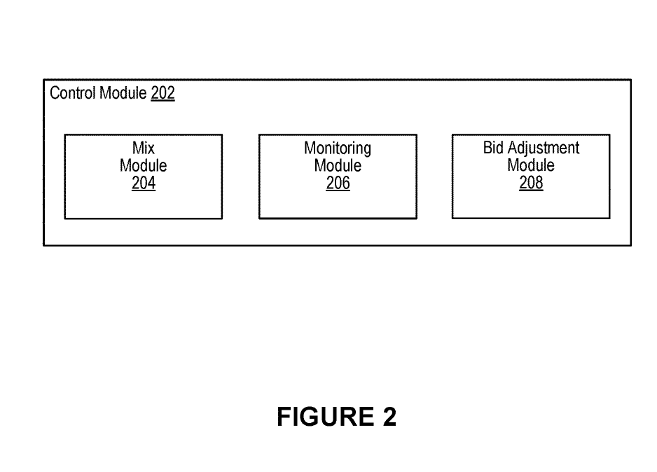

In various embodiments, the auction module 104 is configured to conduct online auctions (e.g., real-time bidding auctions) when impression opportunities arise. Such auctions typically determine which content items will be used to satisfy various impression opportunities. The auction module 102 can be implemented to conduct such auctions using generally known approaches. In general, the online auction involves buyers bidding for impression opportunities. In other words, buyers specify bids for content items that they would like to present through an impression opportunity. Typically, the bidding process ensures that each impression opportunity is sold at the maximum price. If an auction is won, the buyer's content item is displayed to a user, or users, that are targeted through the respective impression opportunity. As used herein, a buyer may refer to an advertiser that seeks to promote an ad for goods and/or services. Such goods and/or services may or may not be affiliated with the social networking system. Further, the buyer may also refer to some group, or organization, that seeks to promote entities (e.g., page suggestions, web site suggestions, etc.) that may or may not be affiliated with the social networking system. The control module 106 is configured to regulate a specified mix of content item types to be presented to users through the social networking system. More details regarding the control module 106 will be provided below with reference to FIG. 2.

FIG. 2 illustrates an example of a control module 202 configured to regulate a mixture of content items, according to an embodiment of the present disclosure. In some embodiments, the control module 106 of FIG. 1 can be implemented as the control module 202. As shown in FIG. 2, the control module 202 can include a mix module 204, a monitoring module 206, and a bid adjustment module 208.

In various embodiments, the mix module 204 can be used to define a mix, or mixture rate, for various types of content items. This mix may be defined using percentages, fractions, or ratios, for example. In general, the specified mix indicates the respective rates, or ratios, at which one or more types of content items are presented to users in the social networking system. In some instances, the mix can be specified as a fraction for blending two types of content items. For example, a mix can be defined to indicate that page recommendations should be presented 25 percent of the time while all other types of content items should be presented 75 percent of the time. In another example, the mix of the same content item type in different categories can be regulated. For example, the mix can be defined to indicate that large page recommendations should be presented 40 percent of the time while small pages should be presented 60 percent of the time. In some instances, the mix can be specified as a ratio that defines the rates at which three or more types of content items are to be presented in relation to one another. For example, the mix may be defined as a ratio 3:2:4:1 to specify that small page recommendations should be presented 30 percent of the time, that large page recommendations should be presented 20 percent of the time, that advertisements should be presented 40 percent of the time, and that all other types of content items should be presented 10 percent of the time.

Depending on the implementation, a mix specified for content item types may affect the rates at which content items are presented to all, or only a certain portion, of users of the social networking system. For example, users may be grouped into one or more channels and each channel may be associated with a respective mix defined for various content item types. In this example, a channel may be used to target users that share one or more characteristics (e.g., geographic region, interest, age group, gender, experiment, etc.). In some embodiments, a separate auction is held for each channel. Thus, in such embodiments, content items targeting users associated with a first channel compete in a first online auction while content items targeting users associated with a second channel compete in a different, second online auction.

The monitoring module 206 is configured to measure and store the actual mix at which various types of content items are being presented to users of the social networking system. For example, each time a content item is presented through the social networking system, the monitoring module 206 can log the type of content item that was presented as well as a timestamp. This information can be used to determine the respective rates at which various types of content items were presented over one or more periods of time (e.g., every 5 minutes, hourly, daily, weekly, monthly, or any other specified period of time). Each period of time in which the rates are measured may be referred to a cycle or iteration. The rates measured for content item types over a period of time can be referred to as the actual mix. When applicable, a separate actual mix can be determined for each channel being utilized. In some embodiments, the monitoring module 206 is configured to determine the actual mix by determining a power calculation of a categorical distribution. In some embodiments, the monitoring module 206 also determines and stores data describing the last action taken by the bid adjustment module 208 during a given cycle. For example, the last action may indicate that a bid weight for a content item type was updated, that the actual mix and a desired mix for content item types were within tolerance, that no corrective action was taken in the previous cycle, or any errors encountered during any of the operations performed by the control module 202.

The bid adjustment module 208 is configured to automatically update the respective weights associated with one or more types of content items, for example, for purposes of enforcing a specified mix for those types of content items. If multiple channels are being utilized, then the bid adjustment module 208 can automatically update the respective weights for content item types in each of the channels, as described below. In various embodiments, the bid adjustment module 208 determines whether or not corrective action is needed upon completion of each cycle in which the actual mix of the presented content item types is measured. When determining bid weights for content item types, the bid adjustment module 208 determines whether the actual mix of the content item types that were presented satisfies a specified mix for those content item types. For example, a mix ratio of large page recommendations to small page recommendations may be specified as 1:3. If the actual mix of large page recommendations to small page recommendations is determined to be 1:6 in a given cycle, then the bid adjustment module 208 can take corrective action to update the respective bid weights assigned to large page recommendations so that more large page recommendations are able to seize impression opportunities, thereby helping reduce the discrepancy between the actual mix ratio and the specified mix ratio going forward. In some embodiments, a tolerance value, or bound, is used to determine whether or not corrective action should be triggered. For example, a tolerance value of 10 percent may be specified. In this example, the mix ratio of large page recommendations to small page recommendations can be defined as 1:3. If the actual mix ratio of large page recommendations to small page recommendations is determined to be 1:4 in a given cycle, then the bid adjustment module 208, in this example, will not take corrective action since the difference between the actual mix ratio and the specified mix ratio is within the 10 percent tolerance. In some embodiments, if the difference between the actual mix and the specified mix is within tolerance, then the bid adjustment module 208 will delay any corrective action until the next cycle during which the monitoring module 206 again measures the actual mix of the content item types.

If the bid adjustment module 208 determines that corrective action is needed, then bid weights can be determined for the types of content items that are being regulated. In some embodiments, a bid weight for a content item type is determined as follows:

$${W}^{′} = W + λ * W * \frac{R - r}{min ( R , r )} ,$$

where λ is a specified learning value, wherein R is the actual mix measured for the content item type, where r is the target mix for the content item type, where W is the previously assigned bid weight that was assigned to the content item type, and where W′ is the new bid weight to be assigned to the content item type.

In this example approach for calculating the bid weight, the bid adjustment module 208 calculates the divergence of the actual mix to the target mix (e.g., (R−r)). This divergence provides the direction of the update. The bid adjustment module 208 scales this divergence by the minimum of the actual mix and the target mix (e.g., min(R, r)). As a result of this scaling, the bid weight can be adjusted more when the divergence is greater. The bid adjustment module 208 then scales this result by the magnitude of the previous bid weight and then scales the result down to the size of the learning value.

As mentioned, such bid weights can be adjusted automatically, for example, upon measurement of the actual mix of content item types being presented. Once a bid weight adjustment for a content item type is determined, the bid adjustment module 208 can adjust any bids that are associated with such content item types as follows:

B′ᵢ=Bᵢ*wᵢ,

where B is a bid associated with a content item of type i, where w is a bid weight determined for content items of type i, and where B′ is the adjusted bid for the content item that can be used to compete for impression opportunities in subsequent online auctions.

As mentioned, a determination for updating a bid weight can be made in each cycle after measurement of the actual mix of content item types being presented. The bid adjustment module 208 can store the respective bid weight for each content item type and can use the respective bid weights to modify bids for content items of that type when corrective action is needed.

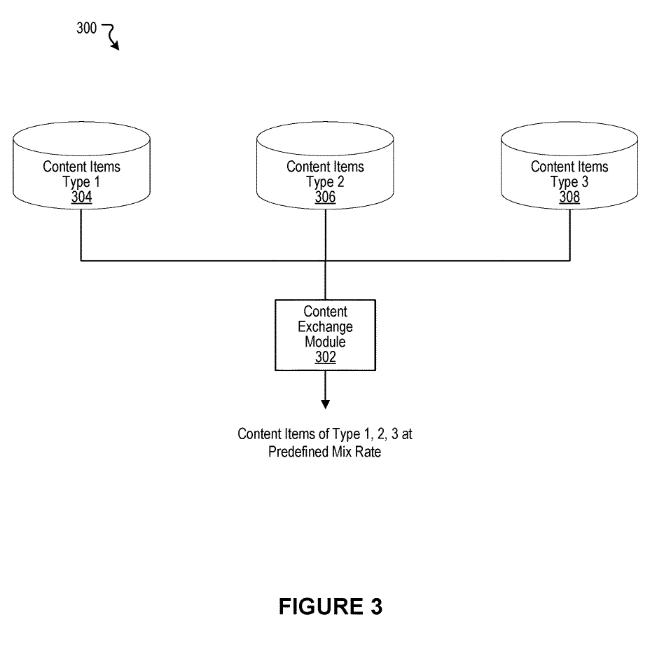

FIG. 3 illustrates an example diagram 300 illustrating the blending of content item types, according to an embodiment of the present disclosure. In the example of FIG. 3, the content exchange module 302 is configured to manage the mix of content items of type 1, type 2, and type 3 based on a specified mix rate. In some embodiments, the content exchange module 102 of FIG. 1 can be implemented as the content exchange 302. The example diagram 300 illustrates three separate data stores 304, 306, and 308 that each store content items of type 1, type 2, and type 3, respectively. The separation of data stores 304, 306, and 308 is provided merely for illustrative purposes and the various types of content items can also be stored in the same data store. In the example of FIG. 3, the content exchange module 302 can periodically determine the respective rates at which content items of types 1, 2, and 3 were presented to users of the social networking system over predefined periods of time (e.g., cycles). In general, each content item can be associated with a respective bid. Further, content items are presented through impression opportunities based at least in part on a real-time bidding auction. Thus, a content item is presented through the social networking system when the content item is associated with a bid that wins a real-time bidding auction for an impression opportunity. In each cycle, the content exchange module 302 can determine whether the respective rates measured over the period of time are inconsistent with the specified mix of the types of content items to be presented. If such an inconsistency exists, the content exchange module 302 can determine one or more bid weights for adjusting bids associated with one or more of the content items of type 1, type 2, or type 3. Next, the content exchange module 302 can adjust the respective bids associated with at least one type of content item by a corresponding bid weight. In various embodiments, the bid weights are determined for purposes of enforcing the specified mix of content item types.

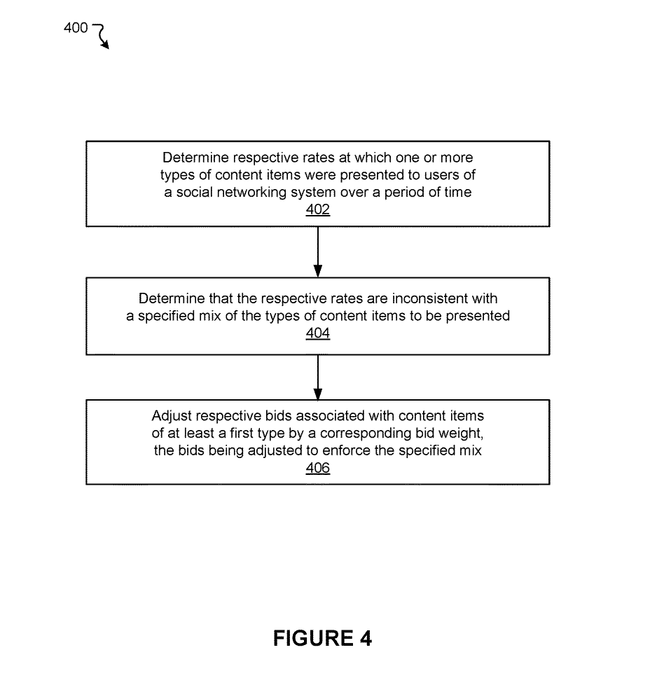

FIG. 4 illustrates an example process 400 for blending content item types, according to an embodiment of the present disclosure. It should be appreciated that there can be additional, fewer, or alternative steps performed in similar or alternative orders, or in parallel, within the scope of the various embodiments discussed herein unless otherwise stated. At block 402, respective rates at which one or more types of content items were presented to users of the social networking system over a period of time are determined. Each content item can be associated with a respective bid. Further, content items are presented through impression opportunities based at least in part on a real-time bidding auction. At block 404, a determination is made that the respective rates measured over the period of time are inconsistent with a specified mix of the types of content items to be presented. At block 406, the respective bids associated with content items of at least a first type are adjusted by a corresponding bid weight, wherein the bids are adjusted to enforce the specified mix.

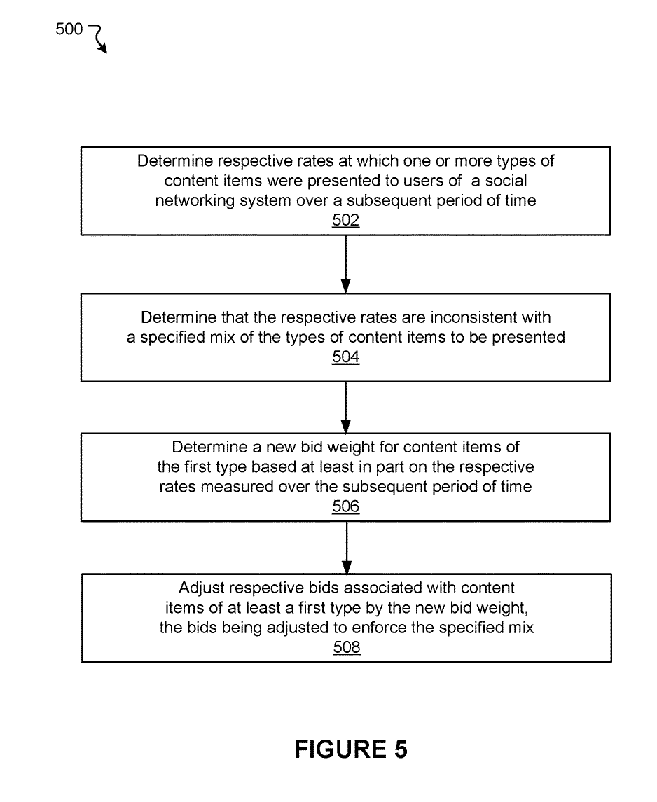

FIG. 5 illustrates another example process 500 for blending content item types, according to an embodiment of the present disclosure. It should be appreciated that there can be additional, fewer, or alternative steps performed in similar or alternative orders, or in parallel, within the scope of the various embodiments discussed herein unless otherwise stated. At block 502, respective rates at which the one or more types of content items were presented to users of the social networking system over a subsequent period of time are determined. At block 504, a determination is made that the respective rates measured over the subsequent period of time are inconsistent with the specified mix. At block 506, a new bid weight for content items of the first type is determined based at least in part on the respective rates measured over the subsequent period of time. At block 508, the respective bids associated with content items of the first type are adjusted by the new bid weight.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices (or systems) that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content. As discussed previously, it should be appreciated that there can be many variations or other possibilities.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a content exchange module 646. The content exchange module 646 can, for example, be implemented as the content exchange module 102 of FIG. 1. As discussed previously, it should be appreciated that there can be many variations or other possibilities.

### Hardware Implementation

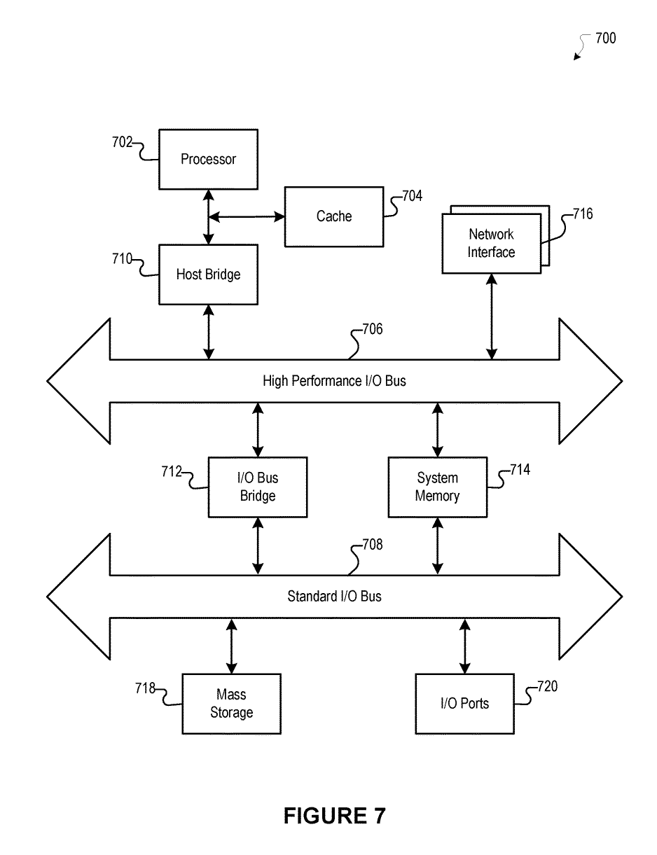

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a social networking system, respective rates at which one or more types of content items were presented to users of the social networking system over a period of time, wherein each content item is associated with a respective bid, and wherein content items are presented through impression opportunities based at least in part on a real-time bidding auction;
determining, by the social networking system, that the respective rates measured over the period of time are inconsistent with a specified mix of the types of content items to be presented; and
causing, by the social networking system, the respective bids associated with content items of at least a first type to be adjusted by a corresponding bid weight, wherein the bids are adjusted to enforce the specified mix.

2. The computer-implemented method of claim 1, wherein the mix specifies a ratio of content items of the first type to content items of a second type.

3. The computer-implemented method of claim 1, wherein the mix specifies a ratio of at least content items of the first type, to content items of a second type, and to content items of a third type.

4. The computer-implemented method of claim 1, the method further comprising:
determining, by the social networking system, the respective bid weight for content items of the first type based at least in part on the respective rates measured over the period of time.

5. The computer-implemented method of claim 1, the method further comprising:
determining, by the social networking system, respective rates at which the one or more types of content items were presented to users of the social networking system over a subsequent period of time;
determining, by the social networking system, that the respective rates measured over the subsequent period of time are inconsistent with the specified mix;
determining, by the social networking system, a new bid weight for content items of the first type based at least in part on the respective rates measured over the subsequent period of time; and
causing, by the social networking system, the respective bids associated with content items of the first type to be adjusted by the new bid weight.

6. The computer-implemented method of claim 1, wherein determining that the respective rates measured over the period of time are inconsistent with the specified mix further comprises:
determining, by the social networking system, that a difference between the respective rates and the specified mix exceeds a tolerance value.

7. The computer-implemented method of claim 1, the method further comprising:
causing, by the social networking system, the respective bids associated with content items of at least a second type to be adjusted by a bid weight corresponding to the second type, wherein the bids are adjusted to enforce the specified mix.

8. The computer-implemented method of claim 1, wherein causing the respective bids associated with content items of at least the first type to be adjusted further comprises:
causing, by the social networking system, the respective bid associated with each content item of the first type to be increased based at least in part on the bid weight.

9. The computer-implemented method of claim 1, wherein causing the respective bids associated with content items of at least the first type to be adjusted further comprises:
causing, by the social networking system, the respective bid associated with each content item of the first type to be decreased based at least in part on the bid weight.

10. The computer-implemented method of claim 1, wherein the types of content items include at least one of advertisements or various entities accessible through the social networking system.

11. A system comprising:
at least one processor; and
a memory storing instructions that, when executed by the at least one processor, cause the system to perform:
determining respective rates at which one or more types of content items were presented to users of the social networking system over a period of time, wherein each content item is associated with a respective bid, and wherein content items are presented through impression opportunities based at least in part on a real-time bidding auction;
determining that the respective rates measured over the period of time are inconsistent with a specified mix of the types of content items to be presented; and
causing the respective bids associated with content items of at least a first type to be adjusted by a corresponding bid weight, wherein the bids are adjusted to enforce the specified mix.

12. The system of claim 11, wherein the mix specifies a ratio of content items of the first type to content items of a second type.

13. The system of claim 11, wherein the mix specifies a ratio of at least content items of the first type, to content items of a second type, and to content items of a third type.

14. The system of claim 11, wherein the system further performs:
determining the respective bid weight for content items of the first type based at least in part on the respective rates measured over the period of time.

15. The system of claim 11, wherein the system further performs:
determining respective rates at which the one or more types of content items were presented to users of the social networking system over a subsequent period of time;
determining that the respective rates measured over the subsequent period of time are inconsistent with the specified mix;
determining a new bid weight for content items of the first type based at least in part on the respective rates measured over the subsequent period of time; and
causing the respective bids associated with content items of the first type to be adjusted by the new bid weight.

16. A non-transitory computer-readable storage medium including instructions that, when executed by at least one processor of a computing system, cause the computing system to perform a method comprising:
determining respective rates at which one or more types of content items were presented to users of the social networking system over a period of time, wherein each content item is associated with a respective bid, and wherein content items are presented through impression opportunities based at least in part on a real-time bidding auction;
determining that the respective rates measured over the period of time are inconsistent with a specified mix of the types of content items to be presented; and
causing the respective bids associated with content items of at least a first type to be adjusted by a corresponding bid weight, wherein the bids are adjusted to enforce the specified mix.

17. The non-transitory computer-readable storage medium of claim 16, wherein the mix specifies a ratio of content items of the first type to content items of a second type.

18. The non-transitory computer-readable storage medium of claim 16, wherein the mix specifies a ratio of at least content items of the first type, to content items of a second type, and to content items of a third type.

19. The non-transitory computer-readable storage medium of claim 16, wherein the computing system further performs:
determining the respective bid weight for content items of the first type based at least in part on the respective rates measured over the period of time.

20. The non-transitory computer-readable storage medium of claim 16, wherein the computing system further performs:
determining respective rates at which the one or more types of content items were presented to users of the social networking system over a subsequent period of time;
determining that the respective rates measured over the subsequent period of time are inconsistent with the specified mix;
determining a new bid weight for content items of the first type based at least in part on the respective rates measured over the subsequent period of time; and
causing the respective bids associated with content items of the first type to be adjusted by the new bid weight.
